(19) United States
(12) Patent Application Publication
(10) Pub. No.: US 2008/0238085 A1
(43) Pub. Date: Oct. 2, 2008

(54) Printable form for correspondence and organized filing

(75) Inventor: Anthony S. Volpe, Doylestown, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Volpe & Koenig, P.C., Philadelphia, PA (US)

(21) Appl. No.: 11/729,002

(22) Filed: Mar. 28, 2007

(51) Int. Cl. B42D 15/00; B65D 27/00

(52) U.S. Cl. 283/81; 229/68.1

(57) ABSTRACT

A printable form for correspondence and organized filing is disclosed comprising a sheet of material of predetermined size wherein a portion is scored to define a printable tab that extends outward from the sheet of material when the scored portion is removed, providing for faster, more organized, and efficient filing and retrieval of information.

### FIELD OF INVENTION

This invention relates, in general, to folders, dividers, and mailers.

### BACKGROUND

There has been a vast increase in the amount of information transmitted, stored, filed, and organized electronically due to continually faster, more powerful, and more sophisticated computing technology.

Nevertheless, the ever-increasing number of private parcel carriers, such as Federal Express®, United Parcel Service®, and DHL®, the increasing number of mail services offered by these private carriers as well as the increasing number of mail services offered by the United States Postal Service, demonstrate that businesses, individuals, and other entities continue to generate, receive and send enormous volumes of paper.

Widespread use of paper remains and is likely to remain for a long time, for a number of reasons. First, there are some entities that simply do not have or use computers. Second, because of the unreliability of some computing technology, many times it is desirable or even imperative to generate, maintain, and transmit back-up, “hard copies” of electronically stored, received or transmitted data such as contracts, estate documents, patent and trademark applications, etc. Last, some information is available only in hard copy.

This vast amount of information generated and sent in hard copy format costs businesses and individuals a great deal of time and money to manage, organize and send. In an effort to reduce these costs and use of valuable resources, various products and methods have been introduced. While these products have been somewhat helpful, they have many deficiencies.

The following outlines products for efficiently storing and organizing paper information. Discussed thereafter are products for efficiently transmitting paper information.

Products for Efficiently Storing Information:

Products for storing information are printable folders and paper dividers for binders, each having protruding tabs. The tabs are usually printable and are affixed to the right-hand edge of the front face of the folder or divider, from which the tab protrudes outward. Because the tab is printable, a user can affix an identifying mark upon the tab to identify the contents of the folder or information located around the paper divider. Because the tab protrudes from an edge of the folder or divider, it can be seen more easily in the midst of other folders or papers of similar dimensions, thereby allowing a user to more easily identify and locate a particular folder or section of information without examining its contents.

These tabbed folders and dividers are helpful but suffer from major disadvantages. First, they do not assist a user in locating a document if that document was placed in the wrong folder. This happens often because many times, the person filing the information is unfamiliar with the nature of the document and files it in an improper place. Even if the person filing is familiar with its contents, he or she may misfile it due to human error. Second, these folders do not also assist with the efficient transmission of the document.

There are also removable tabs, which provide many of the advantages of the tabbed folders and dividers, with the added advantage of allowing a user to set up his or her filing system by affixing the removable tab to various folders and dividers. These products are helpful but also suffer from major disadvantages. Namely, the tabs are separate from the document and therefore, must be secured by a user. This requires a great deal of human effort and resources. Furthermore, the tabs detach especially when the document is stored among many other documents or frequently removed and re-filed. Also, these tabbed documents do not assist with the efficient transmission of information.

Products for Efficiently Transmitting Information:

Various types of mailers provide for more efficient and less costly transmission of information. These mailers generally consist of a printable form that is capable of being easily converted into an envelope. In other words, the document(s) and the mailing apparatus are one and the same thereby eliminating the need for a separate document and envelope.

The existing products are helpful but suffer from at least one major disadvantage. Namely, they do not assist with the proper and efficient storage and location of the information located on the mailer. After an entity receives the mailer, there is a great likelihood that it will be misfiled. Further, these mailers generally, do not allow for easy storage in a binder, such as a three-ring binder, because they generally do not contain apertures.

In light of the aforementioned products and their respective deficiencies, there is a need for a printable form having a printable tab protruding from the printable form at various locations, wherein the tab is securely affixed to the printable form and therefore, does not have be manually affixed to the printable form and is more secure. It is also desirable for such a product to be easy and efficient to create and transmit information.

### SUMMARY

The present invention satisfies these needs. The present invention is a printable form comprising a sheet of material of a predetermined size having front and back faces and top, bottom, and left and right lateral edges, and a portion of at least one of the lateral edges scored to define a tab of a predetermined size.

The present invention is also a method of using the printable form wherein a sender prints information on the sheet of material of predetermined size and then converts it to a mailer by printing a mailing address on the back face of the sheet of material of predetermined size, placing postage on the back face of the sheet of material of predetermined size, placing the printable form so that the front face faces upward, folding the sheet of material of predetermined size, and affixing the folded sheets of material together.

The present invention is also a method for creating a printable form comprising acquiring a sheet of material of a predetermined size having front and back faces and top, bottom, and left and right lateral edges, puncturing a portion of at least one lateral edge to define a tab of a predetermined size, and puncturing a portion of at least one lateral edge to create an aperture of a predetermined size.

### BRIEF DESCRIPTION OF THE DRAWINGS

FIG. 1 is a top plan view of the front face of an embodiment of a Printable Form for Correspondence and Organized Filing made according to the present invention.

FIG. 1A is a top plan view of the front face of another embodiment of a Printable Form for Correspondence and Organized Filing made according to the present invention.

FIG. 2 is a top plan view of the front face of another embodiment of a Printable Form for Correspondence and Organized Filing made according to the present invention.

FIG. 2A is a top plan view of the front face of another embodiment of a Printable Form for Correspondence and Organized Filing made according to the present invention.

FIG. 3 is a top plan view of the front face of another embodiment of a Printable Form for Correspondence and Organized Filing made according to the present invention.

FIG. 4. is a top plan view of the front face of another embodiment of a Printable Form for Correspondence and Organized Filing made according to the present invention.

FIG. 5 is a top plan view of the back face of another embodiment of a Printable Form for Correspondence and Organized Filing made according to the present invention.

FIG. 6 is a top plan view of the front face of an embodiment of a Printable Form for Correspondence and Organized Filing made according to the present invention.

FIG. 7 is a side view of the front face of another embodiment of a Printable Form for Correspondence and Organized Filing, made according to the present invention.

FIG. 8 is a top plan view of the back face of another embodiment of a Printable Form for Correspondence and Organized Filing, made according to the present invention.

FIG. 9 is a top plan view of the front face of another embodiment of a Printable Form for Correspondence and Organized Filing, made according to the present invention.

### DETAILED DESCRIPTION OF THE PREFERRED EMBODIMENTS

As used below, the terms “printing” and “marking” refer to any letters, numbers, other symbols or colors, etc. placed upon the present invention. Printing or marking may be through various methods, such as manually; i.e., by hand or through use of a printing machine. “Printable” or “markable” refers to the ability to accept and maintain such printing or marking.

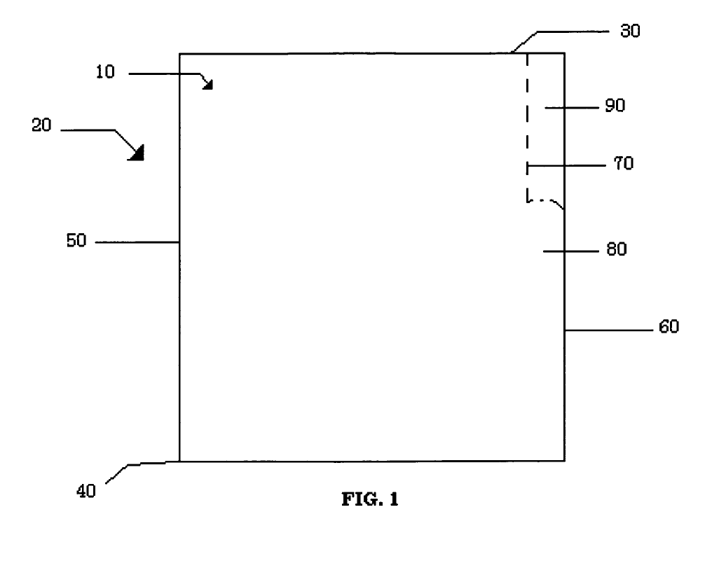

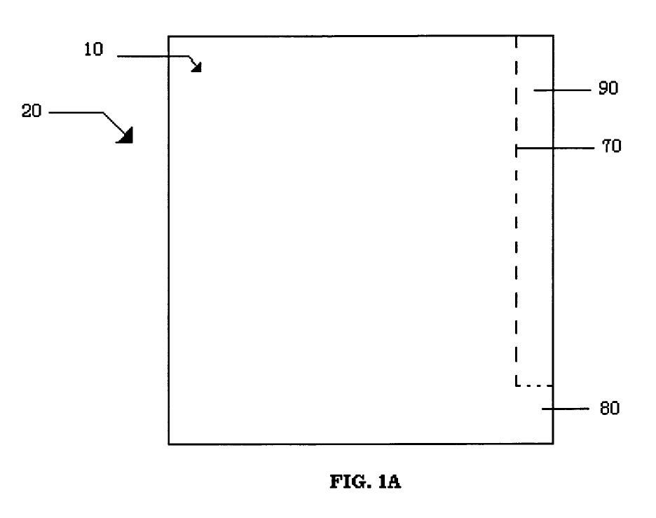

The present invention is described below more specifically with reference to various, preferred embodiments. The following descriptions of preferred embodiments are presented for illustration and description only and are not intended to be exhaustive or to be limited to the precise form disclosed. For example, FIGS. 1-9 show various embodiments of a printable form for correspondence and organized filing, comprised of a rectangular, 8½×11 in. sheet of material of predetermined size 20. However, the sheet 20 may be different shapes and sizes. FIGS. 1-4 and 6 show various embodiments of the present invention comprising no more than two; i.e., first 90 and second 100 scored printable, removable portions and no more than one printable tab 80. However, the present invention may include more or less of these elements.

The following is a discussion of the present invention with reference to the drawings:

FIG. 1 shows an embodiment of a printable form for correspondence and organized filing comprising a sheet of material of a predetermined size 20 having front 10 and back 140 faces and top 30, and bottom 40 edges and left 50 and right 60 lateral edges, a portion 90 of at least one of the lateral edges 60 scored 70 to define a printable tab 80 of a predetermined size. Preferably, the size and shape of the printable tab 80 will correspond to that of the scored 70 portion 90 as shown in 1A.

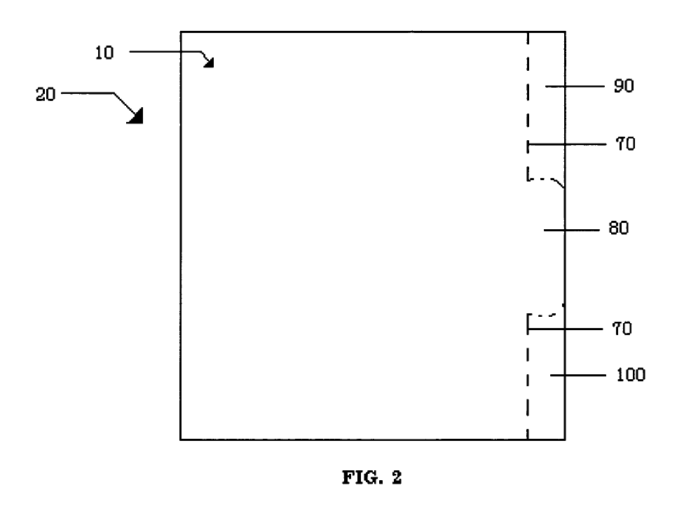

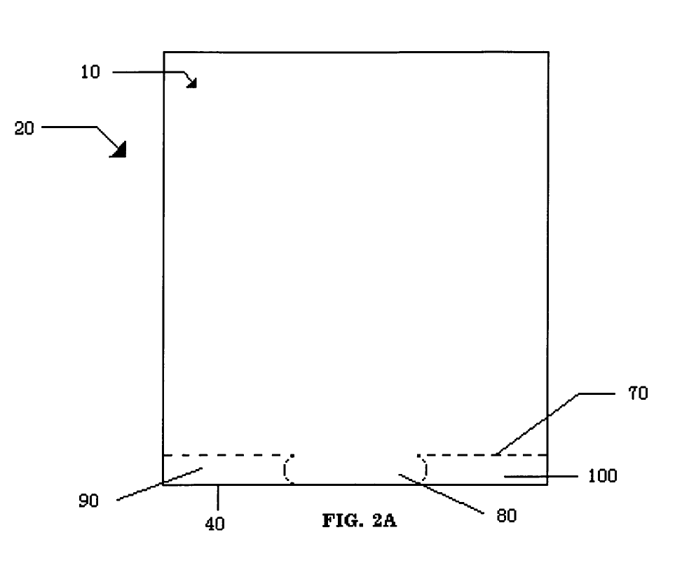

FIG. 2 shows another embodiment of the present invention comprising all of the elements of FIG. 1 as well as a second 100 scored 70, printable portion that further defines a tab 80, positioned below the scored 70 portion 90.

FIG. 2A shows the present invention wherein the scored 70 portions 90 and 100 and the printable tab 80 are located along the bottom edge 40 of the front face 10 of the printable sheet of predetermined size 20.

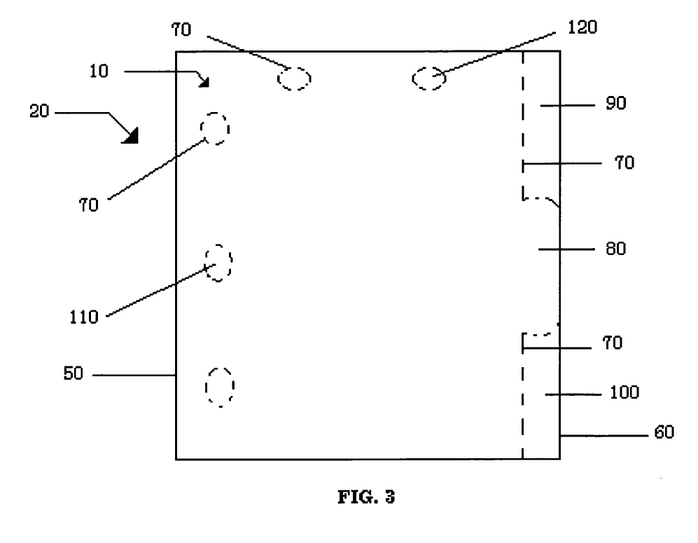

FIG. 3 shows the present invention comprising all of the elements of FIG. 2 and further comprising optional, side 110 and top 120 apertures defined by scoring 70, which allows the printable form to be adapted to various filing systems; for example, binders in which the paper-fastening mechanism is located at the top of the sheet of material of a predetermined size 20 and those in which the fastener is located on a left lateral edge 50 of a printable sheet 20. The side 110 and top 120 apertures may be positioned elsewhere and may vary in area or diameter. Further, these apertures 110 and 120 may be pre-punched rather than defined by scoring 70.

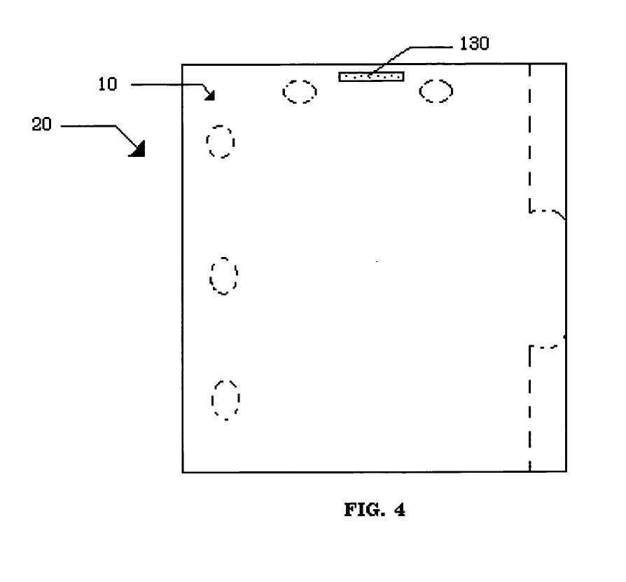

FIG. 4 shows the present invention comprising all of the elements of FIG. 3 and further comprising an adhesive substance 130 affixed to the front face 10 of the sheet of predetermined size 20.

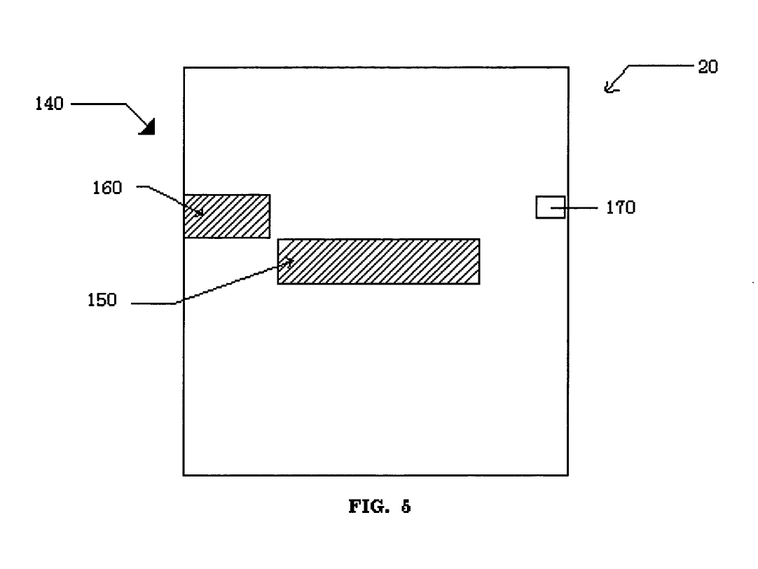

FIG. 5 shows the printable back face 140 of a the sheet of predetermined size 20 where a mailing address 150 return address 160 and postage 170 are printed or affixed thereon.

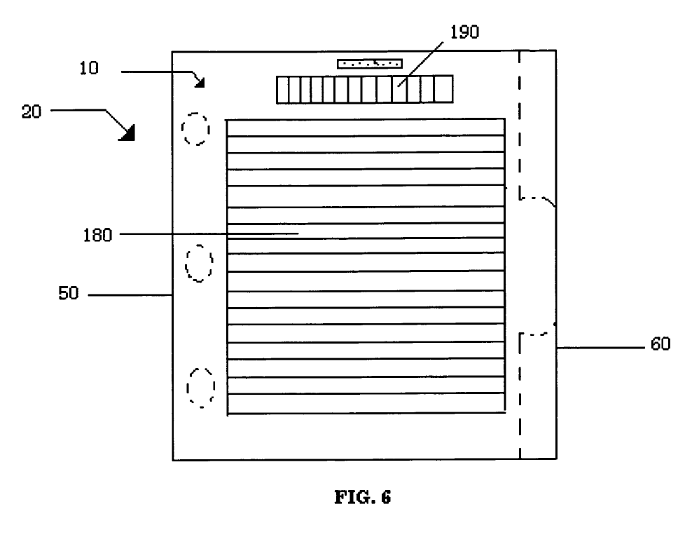

FIG. 6 shows the present invention with all of the elements shown in FIG. 4 with the addition of a correspondence address 190 placed near the top edge 30 of the front face 10 of the sheet of material of predetermined size 20 and correspondence information 180 placed approximate to the middle of the front face 10 of the sheet of material of predetermined size 20.

The present invention may be used for storage and filing information. However, it is preferred that the present invention is also used for correspondence. Outlined below is the preferred procedure for using the printable form.

A sender selects a printable sheet of material of a predetermined size 20 having a printable tab 80. The sender prints, on the tab 80 and/or the scored portions 90, 100, information that identifies the correspondence information 180 to be printed on the body of the sheet of material of a predetermined size 20. Alternatively, the sender selects a sheet of material 20 that has a tab 80 and/or scored portions 90, 100 with this identifying information pre-printed thereon. The sender then prints correspondence information 180 on the sheet of material of predetermined size 20, which preferably, creates an embodiment similar to that shown in FIG. 6.

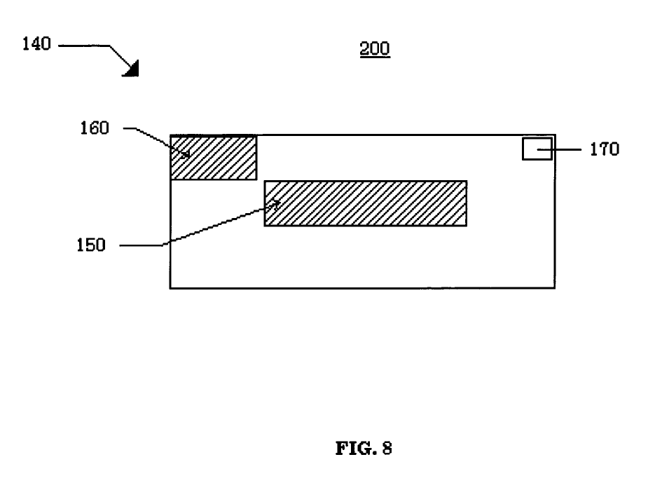

It is preferred that a sender then turns this printable form into a mailer 200 similar to that shown in FIG. 8 to effect efficient correspondence. The preferred steps for creating a mailer 200 are outlined below. While these are preferred, a mailer may be created by other methods or through the below steps, in differing sequence.

The sender prints a mailing address 150 and a return address 160 on the back face 140 of the sheet of material of a predetermined size 20, which creates an embodiment similar to that shown in FIG. 5.

The sender removes a releasable layer (not shown) that covers an adhesive 130 located on the front face 10 of the sheet of material of a predetermined size 20.

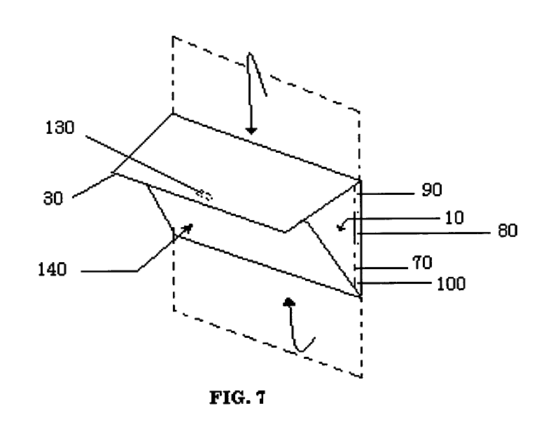

As shown in FIG. 7, the sender folds the bottom edge 40 of the front face 10 of the sheet of material of a predetermined size 20 toward the top edge 30 of the front face 10. As shown in FIG. 7, the sender folds the top edge 30 over the folded bottom edge 40 so that the top edge 30 is now in contact with the back face 140 of the sheet 20. In other words, the top edge 30 overlaps the bottom edge 40, and back face 140 folded portions. The sender then presses the adhesive 130 against the folded, back face 140 of the sheet of material of a predetermined size 20. A mailer 200, similar to that shown in FIG. 8 is created. Optionally, the sender then places postage 170 in the upper left-hand corner of the mailer 200.

The sender then transmits the mailer 200 to a receiver, who receives and stores the printable form as outlined below. The below sequence of steps is preferred and the mailer may be received and used through other methods or through the below steps in varying sequence.

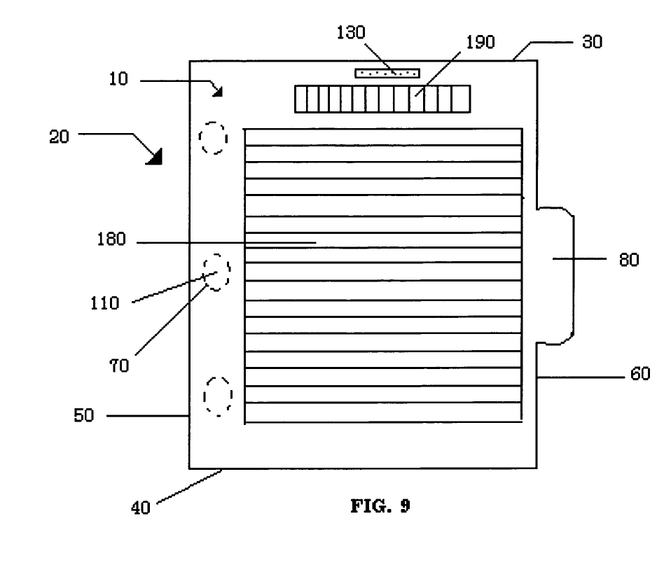

A receiver unfolds the mailer by gently separating the folded bottom edge 40 of the back face 140 of the sheet of material of a predetermined size 20 from the adhesive 130. The receiver then separates the scored 70 portion 90 and if appropriate, the second 100 scored 70 portion. This exposes the printable tab 80, which now, extends from the surrounding edge of the sheet of material of predetermined size 20, as shown in FIG. 9.

If appropriate, the receiver punches either the side 110 or top 120 apertures depending upon his or her storage or filing system or apparatus. For example, the receiver may wish to remove the left edge 50 side 110 apertures if its storage apparatus is a traditional three-ring binder.

The receiver then examines the correspondence 180, and/or the information on the printable tab 80 or scored 70 printable, removable portions 90, 100 and uses this information to determine the proper location in which to file the correspondence. The receiver then files the printable form so that the tab 80 is clearly visible among similarly sized papers, which allows for easy retrieval.

The printable form of the present invention may be created by various methods. The preferred method is disclosed below.

A creator acquires a printable sheet of material of a predetermined size 20, punctures the sheet of material of a predetermined size 20 so as to create a portion 90, scored 70 to define a printable tab 80. A creator then punctures the printable sheet of material of a predetermined size 20 so as to create apertures 110 defined by scoring 70. Optionally, a creator punctures the sheet of material of a predetermined size 20 so as to create a second 100 scored 70 portion further defining a tab 80 or top apertures 120. Optionally, a creator prints on the scored 70 areas 90, 100 or tab 80.

Thus, the present invention provides all of the advantages previously discussed. First, the tab 80 is part of the sheet of material of predetermined size 20 and therefore, is securely affixed to the document and does not have to be affixed manually. Second, because the tab 80 is printable and affixed to the document itself, rather than a file in which the document is located, the document is easily filed or located or restored to its proper location when misfiled. Third, because the present invention is easily converted to a mailer, it is more cheaply, easily and efficiently sent, received and stored. Finally, the printable form is easily created and manufactured.

I claim:

1. A printable form comprising:
a sheet of material of a predetermined size having front and back faces, top and bottom edges, and opposite left and right lateral edges; and
a portion of an edge scored to define a printable tab of a predetermined size.

2. The printable form of claim 1 wherein the edge scored to define a printable tab is a lateral edge.

3. The printable form of claim 2 wherein the lateral edge opposite to the lateral edge scored to define a printable tab includes defined aperture locations.

4. The printable form of claim 2 wherein there are two portions of a lateral edge scored to define a printable tab of a predetermined size.

5. The printable form of claim 2 wherein the lateral edge scored to define a printable tab of a predetermined size is the right lateral edge of the front face.

6. The printable form of claim 1 wherein the edge scored to define a printable tab of a predetermined size is the bottom edge of the front face.

7. The printable form of claim 3 wherein the lateral edge containing defined aperture locations is the left lateral edge of the front face.

8. The printable form of claim 3 wherein the lateral edge containing defined aperture locations is the top lateral edge of the front face.

9. The printable form of claim 3 wherein the defined aperture locations are defined by scoring.

10. The printable form of claim 1 further comprising an adhesive attached to the top lateral edge of the front face.

11. The printable form of claim 10 further comprising a removable layer covering the adhesive.

12. The printable form of claim 1 further comprising printed matter on the front face.

13. The printable form of claim 1 further comprising a mailing address printed on the back face.

14. The printable form of claim 13 further comprising a return address printed on the back face.

15. The printable form of claim 14 further comprising postage affixed to the back face.

16. A method of making the printable form of claim 1 into a mailer comprising:
printing a mailing address on the back face of the sheet of material of predetermined size;
placing postage on the back face of the sheet of material of predetermined size;
placing the printable form so that the front face faces upward;
folding the bottom edge of the front face of the sheet of material of predetermined size toward the top edge of the front face of the sheet of material of predetermined size to form a folded bottom edge;
folding the top edge over the folded bottom edge; and
affixing the folded sheets of material together.

17. The method of claim 16 further comprising printing a return address on the back face of the sheet of material of predetermined size.

18. The method of claim 16 further comprising affixing the folded sheets together by using an adhesive.

19. A method of creating the printable form of claim 2 comprising:
acquiring a sheet of material of a predetermined size having front and back faces and top, bottom, left lateral, and right lateral edges;
puncturing a portion of at least one lateral edge to define a tab of a predetermined size; and
puncturing a portion of at least one lateral edge to create an aperture of a predetermined size.

20. The method of creating the printable form of claim 19 further comprising marking the tab.
